(19) United States
(12) Patent Application Publication
(10) Pub. No.: US 2026/0152044 A1
(43) Pub. Date: Jun. 4, 2026

(54) VEHICLE AIR CONDITIONING SYSTEM

(71) Applicant: NGK INSULATORS, LTD., Nagoya-City (JP)

(72) Inventor: Takafumi HAMADA, Nagoya-Shi (JP)

(73) Assignee: NGK INSULATORS, LTD., Nagoya-City (JP)

(21) Appl. No.: 19/383,899

(22) Filed: Nov. 10, 2025

(30) Foreign Application Priority Data
Dec. 3, 2024 (JP) 2024-210690

(51) Int. Cl. B60H 3/02

(52) U.S. Cl. CPC B60H 3/02

(57) ABSTRACT

A vehicle air conditioning system includes: a humidity controlling device 2; and a duct 3 having the humidity controlling device 2 provided therein and allowing an air 10 from a vehicle interior or a vehicle exterior of a vehicle to flow therethrough, wherein an end face of the humidity controlling device 2 includes: a flow blocking portion 22 disposed in a band shape around an outer periphery of the end face to block the flow of the air 10; and a flow permitting portion 23 disposed on an inner side of the flow blocking portion 22 to permit the flow of the air 10, and wherein the flow blocking portion 22 has a maximum width W of 10 mm or less, when the end face of the humidity controlling device 2 in the duct 3 is viewed from a downstream side in a flow direction of the air 10.

### FIELD OF THE INVENTION

The present invention relates to a vehicle air conditioning system.

### BACKGROUND OF THE INVENTION

In various types of vehicles such as automobiles, there are increasing requirements for improvement of vehicle interior environment. Specific requirements illustrate reduction of an amount of carbon dioxide in the vehicle interior to suppress driver's drowsiness, control of humidity in the vehicle interior, and removal of harmful volatile components such as odor components and allergy-causing components in the vehicle interior. The effective measure for such requirements includes ventilation, but the ventilation causes a large loss of heater energy in winter, leading to a decreased energy efficiency in winter. In particular, a battery electric vehicle (BEV) has a problem that its cruising range is significantly reduced due to its energy loss.

Patent Literature 1 describes an air conditioning system including: an adsorption portion (heater element) having an adsorption layer (functional material-containing layer) that contains an adsorbent (moisture-absorbing material); and an outlet pipe having a first flow path (first path) that communicates an outlet end face of the adsorption portion with a room interior, and a second flow path (second path) that communicates an outlet end face of the adsorption portion with a room exterior such as a vehicle exterior. Patent Literature 1 also discloses that the adsorption portion is sandwiched between frame bodies from both sides.

### CITATION LIST

### Patent Literatures

[Patent Literature 1] Japanese Patent Application Publication No. 2024-144204 A

### SUMMARY OF THE INVENTION

When moisture is desorbed from the adsorbent in the adsorption portion, the adsorption portion is heated by a heating means, and the air containing moisture is discharged to the vehicle exterior. On the other hand, when the moisture is adsorbed to the adsorbent, the heating of the adsorption portion by the heating means is stopped and the dehumidified air is allowed to flow into the vehicle interior. If the moisture desorbed from the adsorbent remains in the duct, the moisture may be introduced into the vehicle interior when the dehumidified air is allowed to flow into the vehicle interior, which may increase the humidity in the vehicle interior.

This invention has been made to solve the problems described above, and one of objects thereof is to provide a vehicle air conditioning system that can reduce the probability of moisture desorbed from the adsorbent remaining in the duct and reduce the probability of that moisture being introduced into a vehicle interior.

As results of intensive studies for vehicle air conditioning systems including humidity controlling devices, the inventor has found the following findings. That is, an end face of the humidity controlling device may be provided with a flow blocking portion disposed in a band shape around an outer periphery of the end face to block the flow of air, and a flow permitting portion disposed on an inner side of the flow blocking portion to permit the flow of air. If the maximum width of the flow blocking portion when the end face inside the duct is viewed from the downstream side in the air flow direction is larger, the air will accumulate at the downstream end face of the adsorption portion, and moisture desorbed from the adsorbent will be more likely to remain in the duct. Therefore, the inventor has found that the above problems can be solved by keeping the maximum width of the flow blocking portion within a predetermined range. This invention has been made on the basis of these findings.
[1] In an embodiment, this invention relates to a vehicle air conditioning system includes: a humidity controlling device including an adsorption portion containing an adsorbent configured to adsorb moisture at a temperature lower than or equal to a predetermined temperature and to desorb the moisture when the temperature exceeds the predetermined temperature, and a heating means configured to heat the adsorption portion; and a duct having the humidity controlling device provided therein and allowing air from a vehicle interior or a vehicle exterior of a vehicle to flow therethrough, the duct having a first flow path for allowing the air to flow into the vehicle interior on a downstream side of the humidity controlling device and a second flow path for discharging the air to the vehicle exterior, wherein an end face of the humidity controlling device includes: a flow blocking portion provided in a band shape around an outer periphery of the end face, the flow blocking portion being configured to block the flow of the air; and a flow permitting portion disposed inside the flow blocking portion, the flow permitting portion being configured to permit the flow of the air, and wherein the flow blocking portion has a maximum width of 10 mm or less, when the end face of the humidity controlling device in the duct is viewed from a downstream side in a flow direction of the air.
[2] This invention may relate to the vehicle air conditioning system according to [1], wherein the maximum width of the flow blocking portion is 9 mm or less.
[3] This invention may relate to the vehicle air conditioning system according to [1] or [2], wherein the humidity controlling device further comprises frame bodies that sandwich the adsorption portion from both sides in the flow direction of the air, and the flow blocking portion is at least partially formed of the frame bodies.
[4] This invention may relate to the vehicle air conditioning system according to any one of [1] to [3], wherein the adsorption portion comprises: a honeycomb structure having an outer wall and partition walls provided on an inner side of the outer wall, the partition walls defining cells to form flow paths for the air, each of the cells extending from a first end face to a second end face of the honeycomb structure; and an adsorbing layer containing an adsorbent provided on a surface of each of the partition walls, and wherein the heating means has a pair of electrodes connected to the honeycomb structure, the heating means being configured to heat the honeycomb structure by passing a current through the honeycomb structure via the pair of electrodes, and at least the partition walls of the honeycomb structure are made of a material having a PTC property.

According to an embodiment of the vehicle air conditioning system of this invention, the maximum width of the flow blocking portion when the end face of the humidity controlling device in the duct is viewed from the downstream side in the flow direction of the air can be 10 mm or less, thereby reducing the probability of moisture desorbed from the adsorbent remaining in the duct and reducing the probability of that moisture being introduced into the vehicle interior.

### BRIEF DESCRIPTION OF THE DRAWINGS

FIG. 1 is a schematic view of a vehicle air conditioning system according to an embodiment of the invention;

FIG. 2 is an external view illustrating the humidity controlling device in FIG. 1 in more detail;

FIG. 3 is an explanatory view illustrating an effect of a maximum width W of a flow blocking portion in FIG. 2;

FIG. 4 is an external view illustrating a variation of the humidity controlling device in FIG. 2;

FIG. 5 is a front view of a humidity controlling device in FIG. 1;

FIG. 6 is a right side view of the humidity controlling device in FIG. 5;

FIG. 7 is an enlarged view illustrating the region VII in FIG. 5;

FIG. 8 is a perspective view illustrating a state where frame bodies are added to the humidity controlling device in FIG. 5;

FIG. 9 is an exploded perspective view of the humidity controlling device in FIG. 8;

FIG. 10 is an explanatory view illustrating an arrangement mode of a sample of a humidity controlling device according to Example; and

FIG. 11 is an explanatory view illustrating another arrangement mode of a sample of a humidity control device in Example.

### DETAILED DESCRIPTION OF THE INVENTION

Hereinafter, embodiments of the invention will be specifically described with reference to the drawings. The invention is not limited to each embodiment, and components can be modified and embodied without departing from the spirit of the invention. Further, various inventions can be formed by appropriately combining a plurality of components disclosed in each embodiment. For example, some components may be removed from all of the components shown in the embodiments. Furthermore, the components of different embodiments may be optionally combined.

### (1. Vehicle Air Conditioning System)

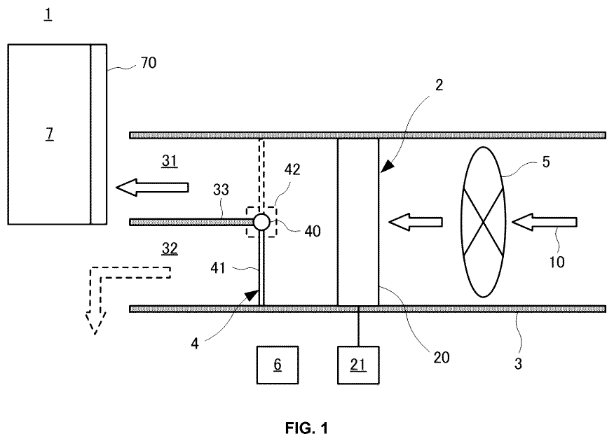

FIG. 1 is a schematic view of a vehicle air conditioning system 1 according to an embodiment of the invention. The vehicle air conditioning system 1 according to an embodiment is a system mounted on a vehicle. The vehicle includes, but not limited to, automobiles and electric rail cars. Non-limiting examples of the automobile include a gasoline vehicle, a diesel vehicle, a gas fuel vehicle using CNG (compressed natural gas) or LNG (liquefied natural gas), a fuel cell vehicle, an electric vehicle, and a plug-in hybrid vehicle. In particular, the vehicle air conditioning system 1 according to an embodiment can be suitably used for a vehicle that has no internal combustion engine such as electric vehicles and electric rail cars.

As illustrated in FIG. 1, the vehicle air conditioning system 1 according to an embodiment of this invention includes a humidity controlling device 2 and a duct 3.

The humidity controlling device 2 has an adsorption portion 20 and a heating means 21. The adsorption portion 20 contains an adsorbent capable of adsorbing moisture at a temperature lower than or equal to a predetermined temperature and desorbing the moisture when the temperature exceeds the predetermined temperature. The heating means 21 is configured to heat the adsorption portion 20. Heating of the adsorption portion 20 by the heating means 21 desorbs the moisture from the adsorbent in the adsorption portion 20.

The duct 3 is a pipe in which the humidify controlling device 2 is provided. The duct 3 is configured to allow an air 10 from a vehicle interior or a vehicle exterior to flow therethrough. The duct 3 has a first flow path 31 and a second flow path 32 on a downstream side of the humidity controlling device 2. The first flow path 31 is a flow path for allowing the air 10 that has passed through the humidity controlling device 2 to flow into the vehicle interior. The second flow path 32 is a flow path for discharging the air 10 that has passed through the humidity controlling device 2 to the vehicle exterior. The first flow path 31 and the second flow path 32 are separated from each other by a duct partition wall 33. Although not shown, the first flow path 31 and the second flow path 32 may be provided at a distance from each other.

The vehicle air conditioning system 1 may further include a valve 4, a blower 5 and a control unit 6.

The valve 8 is configured to be able to switch the flow of the air 10 flowing through the duct 3 between the first flow path 31 and the second flow path 32. The valve 4 can cause the air 10 to flow into the first flow path 31 when the moisture in the air 10 is adsorbed to the humidity controlling device 2, and can cause the air 10 to flow into the second flow path 32 when the moisture is desorbed from the humidity controlling device 2. FIG. 1 shows the air 10 being allowed to flow into the first flow path 31. The valve 4 is not particularly limited as long as it is a valve that is electrically driven and has the function of switching the flow path, and includes electromagnetic valves and electric valves. In an embodiment, the valve 4 includes an opening/closing door 41 supported by a rotating shaft 40 and an actuator 42 such as a motor that rotates the rotating shaft 40.

The blower 5 is configured to feed the air 10 to the humidity controlling device 2. The blower 5 may be provided inside the duct 3. The blower 5 may be provided upstream of the humidity controlling device 2 in the flow direction of the air 10.

The control unit 6 is configured to control the humidity controlling device 2, the valve 4 and the blower 5. The control unit 6 may be electrically connected to the humidity controlling device 2, the valve 4, and the blower 5 by wire or wirelessly. A control mode of the control unit 6 include an adsorption mode in which the blower 5 is activated and the air 10 is allowed to flow into the first flow path 31 without activating the heating means 21, and a regeneration mode in which the blower 5 and the heating means 21 are activated and the air 10 is allowed to flow into the second flow path 32.

The outlet of the first flow path 31 may be positioned to face an HVAC intake port 70 of an HVAC unit 7. The outlet of the second flow path 32 may be positioned so as to be displaced from the HVAC intake port 70. The HVAC system 7 is a unit for performing heating, ventilation, and air conditioning in a vehicle. The HVAC unit 7 can send the air 10 drawn in from the HVAC intake port 70 to the vehicle interior. It is intended that the air 10 flowing through the first flow path 31 is fed to the vehicle interior through the HVAC unit 7, and the air 10 flowing through the second flow path 32 is discharged to the vehicle exterior without passing through the HVAC unit 7.

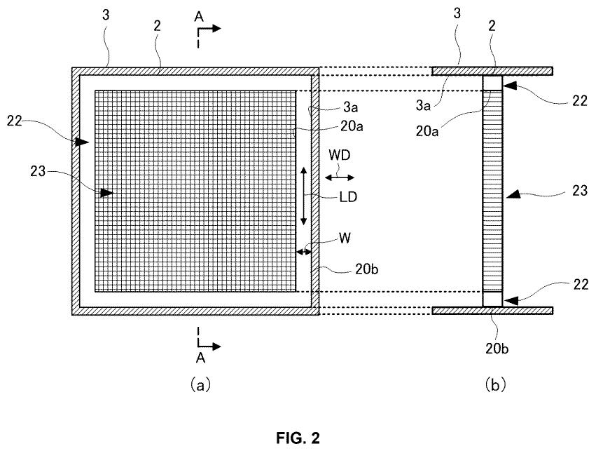

Next, FIG. 2 is an external view illustrating the humidity controlling device 2 in FIG. 1 in more detail, where (a) of FIG. 2 is a front view of the humidity controlling device 2 in the duct 3 as viewed from the downstream side in the flow direction of the air 10 in FIG. 1, and (b) of FIG. 2 is a cross-sectional view of the humidity controlling device 2 and the duct 3 along the line A-A in (a). As illustrated in (a) of FIG. 2, an end face of the humidity controlling device 2 is provided with a flow blocking portion 22 disposed in a band shape around an outer periphery of the end face to block the flow of the air 10, and a flow permitting portion 23 disposed on an inner side of the flow blocking portion 22 to permit the flow of the air 10. As the air 10 passes through the flow permitting portion 23, the moisture in the air 10 can be adsorbed by the adsorbent.

In the vehicle air conditioning system 1 according to this embodiment, when the end face of the humidity controlling device 2 in the duct 3 is viewed from the downstream side in the flow direction of the air 10 as illustrated in (a) of FIG. 2, the maximum width W of the flow blocking portion 22 is 10 mm or less. As described above, the flow blocking portion 22 extends in a band shape in the circumferential direction of the adsorption portion 20. The direction in which the flow blocking portion 22 extends in the band is defined as a length direction LD of the flow blocking portion 22, and the direction orthogonal to the length direction LD in each portion of the flow blocking portion 22 is defined as a width direction WD. For example, in the portion of the flow blocking portion 22 on the right side of (a) of FIG. 2 where the flow blocking portion 22 extends in the up-down direction, the left-right direction is the width direction WD. Further, in the portion of the flow blocking portion 22 on the upper side of (a) of FIG. 2 where the flow blocking portion 22 extends in the left-right direction, the up-down direction is the width direction WD. The maximum width W is the maximum dimension in the width direction WD of the flow blocking portion 22 that appears inside the duct 3. In the embodiment of FIG. 2, the maximum width W is the distance in the width direction WD between an inner peripheral surface 3a of the duct 3 and an inner end 20a of the flow blocking portion 22.

In the embodiment illustrated in FIG. 2, the humidity controlling device 2 is provided inside the duct 3 so that an outer end 20b of the flow blocking portion 22 is positioned inside the inner peripheral surface 3a of the duct 3. In this case, the flow blocking portion 22 is made smaller, so that the maximum width W of the flow blocking portion 22 can be 10 mm or less.

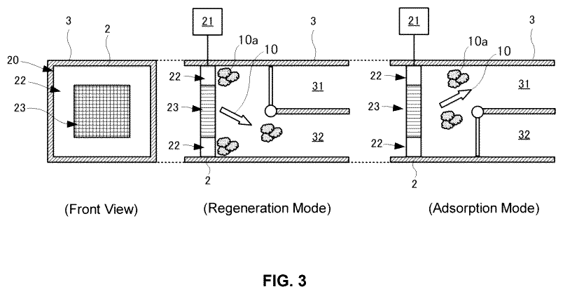

FIG. 3 is an explanatory view illustrating an effect of the maximum width W of the flow blocking portion 22 in FIG. 2. The humidity controlling device 2 illustrated in FIG. 3 has a larger maximum width W than that of the flow blocking portion 22 of the humidity controlling device 2 illustrated in FIG. 2. As illustrated in the center of FIG. 3, during the regeneration mode, the adsorption portion 20 is heated by the heating means 21, and the air 10 containing moisture is allowed to flow through the second flow path 32 and then discharged to the vehicle exterior. On the other hand, as illustrated on the right side of FIG. 3, during the adsorption mode, the heating of the adsorption portion 20 by the heating means 21 is stopped, and the dehumidified air 10 is allowed to flow through the first flow path 31 and the air is introduced into the vehicle interior.

If the maximum width W of the flow blocking portion 22 is larger as in the humidity controlling device 2 illustrated in FIG. 3, the air 10 will accumulate at the downstream end face of the adsorption portion 20, and a moisture 10a desorbed from the adsorbent will be more likely to remain in the duct 3, so that when the dehumidified air 10 is allowed to flow into the vehicle interior during the adsorption mode, the moisture 10a may be introduced into the vehicle interior, which may increase the humidity in the vehicle interior. In the vehicle air conditioning system 1 according to this embodiment, the maximum width W of the flow blocking portion 22 is 10 mm or less, so that the amount of the air 10 remaining at the downstream end face of the adsorption portion 20 can be reduced. This can reduce the probability that the moisture 10a desorbed from the adsorbent will remain in the duct 3, and reduces the probability that the moisture will be introduced into the vehicle interior. The maximum width W of the flow blocking portion 22 is more preferably 9 mm or less, and even more preferably 5 mm or less.

During the regeneration mode, the adsorption portion 20 is heated by the heating means 21. Therefore, the air 10 containing the moisture 10a is warm, and the air 10 containing the moisture 10a is likely to accumulate particularly in the upper portion on the downstream side of the adsorption portion 20. In order to more reliably reduce such accumulation of the air 10, it is preferable to set the maximum width W of the flow blocking portion 22, particularly in the upper portion of the end face, as described above.

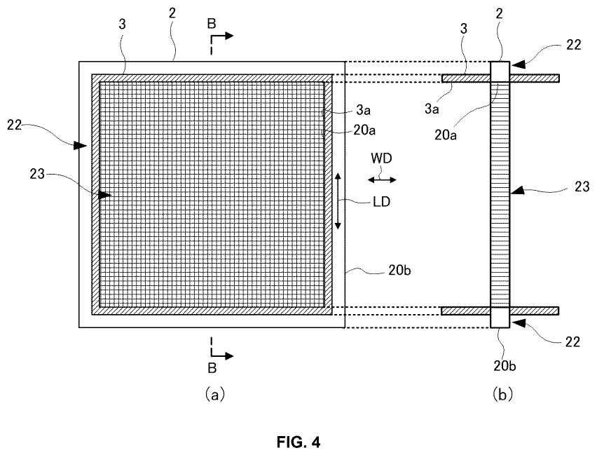

Next, FIG. 4 is an external view illustrating a variation of the humidity controlling device 2 in FIG. 2, where (a) of FIG. 4 is a front view of the humidity controlling device 2 in the duct 3 as viewed from the downstream side in the flow direction of the air 10 in FIG. 1, and (b) of FIG. 4 is a cross-sectional view of the humidity controlling device 2 and the duct 3 along the line B-B in (a).

As illustrated in FIG. 4, the humidity controlling device 2 may be provided inside the duct 3 so that an outer end 20b of the flow blocking portion 22 is located outside the duct 3. In this case, by adjusting the positional relationship between the inner end 20a of the flow blocking portion 22 and the inner peripheral surface 3a of the duct 3, the maximum width W of the flow blocking portion 22 can be 10 mm or less. In the embodiment illustrated in FIG. 4, the inner end 20a of the flow blocking portion 22 and the inner peripheral surface 3a of the duct 3 are matched to each other, and the maximum width W of the flow blocking portion 22 is substantially 0 mm.

### (2. Regarding Humidity Controlling Device)

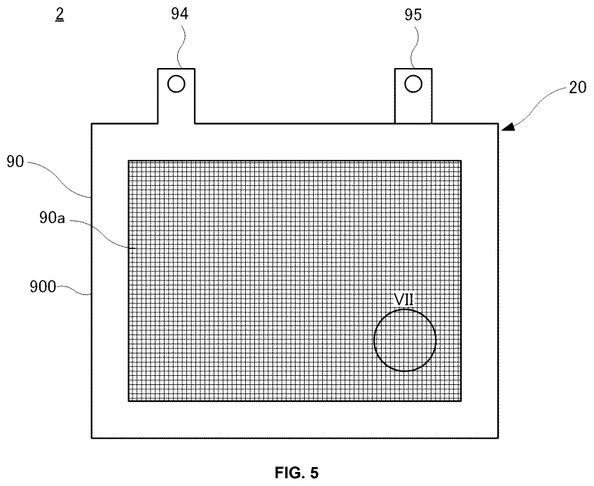

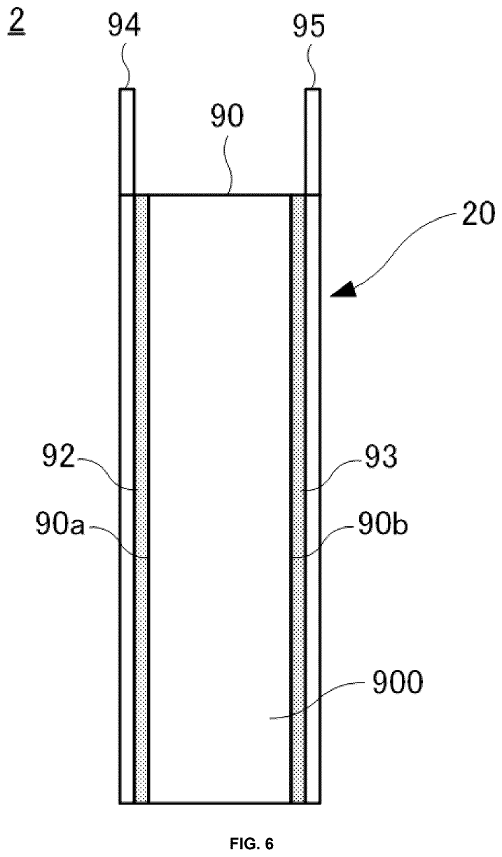

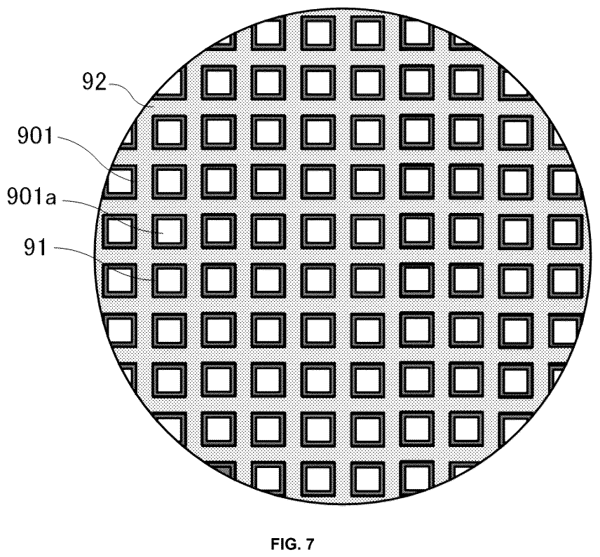

Next, FIG. 5 is a front view illustrating the humidity controlling device 2 in FIG. 1, FIG. 6 is a right side view illustrating the humidity controlling device 2 in FIG. 5, and FIG. 7 is an enlarged view illustrating the region VII in FIG. 5.

As illustrated in FIGS. 5 to 7, the adsorption portion 20 of the humidity controlling device 2 according to this embodiment has a honeycomb structure 90 and an adsorbing layer 91. The honeycomb structure 90 includes: an outer wall 900; and partition walls 901 provided on an inner side of the outer wall 900, the partition walls 701 defining cells 901a to form flow paths for the air 10 each extending from a first end face 90a to a second end face 90b of the honeycomb structure 90. The adsorbing layer 91 is a layer containing the adsorbent as described above, and is provided on each surface of the partition walls 901 as illustrated in FIG. 7. As the air 10 passes through the cells 901a between the first end face 90a and the second end face 90b, the moisture in the air 10 is adsorbed by the adsorbent in the adsorbing layer 91.

In such a humidity controlling device 2, the heating means 21 has a pair of electrodes 92, 93 connected to the honeycomb structure 90, and heats the honeycomb structure 90 by applying an electric current to the honeycomb structure 90 through the pair of electrodes 92, 93. Hereinafter, when the pair of electrodes 92, 93 are to be distinguished from each other, one will be referred to as a first electrode 92 and the other as a second electrode 93.

As particularly illustrated in FIG. 6, the first electrode 92 is provided on the first end face 90a of the honeycomb structure 90, and the second electrode 93 is provided on the second end face 90b of the honeycomb structure 90. The first electrode 92 and the second electrode 93 are provided on the end face of the outer wall 900, and also provided on the end face of the partition walls 901 as illustrated in FIG. 7. The cells 901a do not plug the first electrode 92 and the second electrode 93. However, a part of cells 901a may be plugged by the first electrode 92 and/or the second electrode 93.

As shown in FIGS. 5 and 6, a first metal terminal 94 may be provided on the first electrode 92, and a second metal terminal 95 may be provided on the second electrode 93. The first metal terminal 94 and the second metal terminal 95 are formed as rectangular ring bodies attached to the outer peripheral portions of the first end face 90a and the second end face 90b, respectively. The first metal terminal 94 and the second metal terminal 95 are provided with extending portions each extending from the rectangular frame outward in the width direction of the honeycomb structure 90.

A positive electrode of a power source (not shown) is connected to one extending portion of the first metal terminal 94 and the second metal terminal 95, and a negative electrode of the power source is connected to the other extending portion of the first metal terminal 94 and the second metal terminal 95. Assuming that the positive electrode is connected to an extending portion of the first metal terminal 94 and the negative electrode is connected to an extending portion of the second metal terminal 95, the current from the first metal terminal 94 spreads over the first end face 90a through the first electrode 92, flows through the honeycomb structure 90 in the extending direction of the cells 901a, and flows on the second end face 90b through the second terminal 93 into the second metal terminal 95. The current flows in such a manner, thereby heating the honeycomb structure 90 uniformly. The flow blocking portion 22 can be at least partially formed of the first metal terminal 94 and the second metal terminal 95.

In the honeycomb structure 90, at least the partition walls 901 may be made of a material having a PTC (Positive Temperature Coefficient) property. Further, the material having the PTC property has characteristics such that when the temperature increases to exceed the Curie point, the resistance value is sharply increased, making it difficult for electricity to flow.

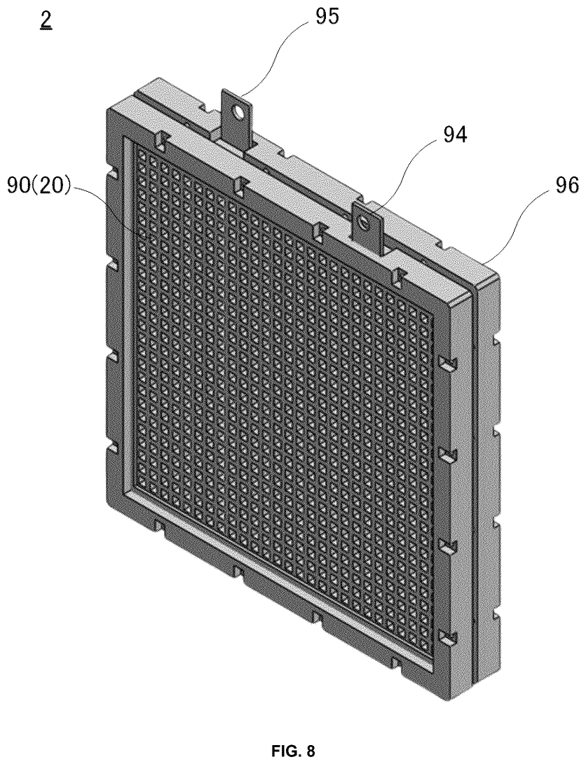

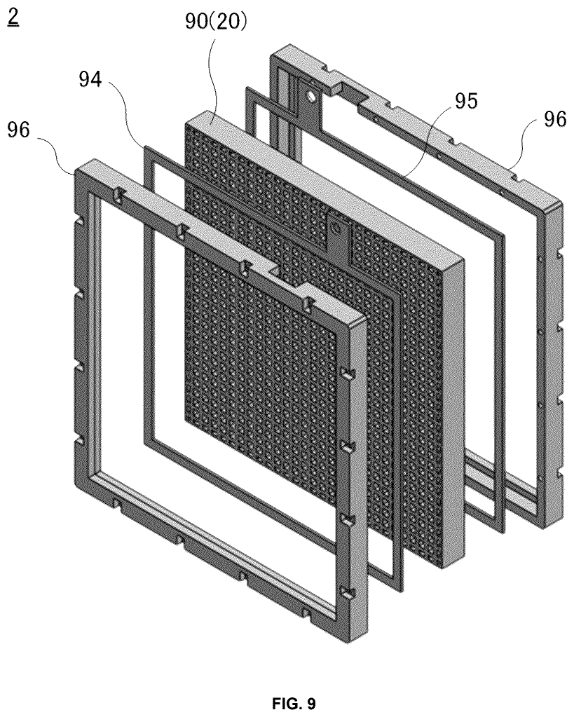

Next, FIG. 8 is a perspective view illustrating a state where frame bodies 96 are added to the humidity controlling device 2 in FIG. 5, and FIG. 9 is an exploded perspective view of the humidity controlling device 2 in FIG. 8. As illustrated in FIGS. 8 and 9, the humidity controlling device 2 may further include frame bodies 96 that hold the honeycomb structure 90 (the adsorption portion 20) from both sides in the flow direction of the air 10. Each frame body 96 is a rectangular ring body made of an insulating material such as polyphenylene sulfide, polybutylene terephthalate, and nylon 66. The frame bodies 96 are provided on both sides of the honeycomb structure 90 so as to overlap with the first metal terminal 94 and the second metal terminal 95. The flow blocking portion 22 may be at least partially formed of the frame bodies 96.

Hereinafter, each of the components of the humidity controlling device 2 will be described in detail.

### (2-1. Regarding Honeycomb Structure)

The shape of the honeycomb structure 90 is not particularly limited. For example, an outer shape of a cross section of the honeycomb structure 90 orthogonal to the flow path direction (extending direction of the cells 901a) can be polygonal such as quadrangular (rectangular, square), pentagonal, hexagonal, heptagonal, and octagonal, circular, oval (egg-shaped, elongated circular, elliptical, rounded rectangular, etc.), or the like. The end faces (first end face 90a and second end face 90b) have the same shape as the cross section. Also, when the cross section and the end faces are polygonal, the corners may be chamfered.

The shape of each cell 901a is not particularly limited, but it may be polygonal such as quadrangular, pentagonal, hexagonal, heptagonal, and octagonal, circular, or oval in the cross section of the honeycomb structure 90 orthogonal to the flow path direction. These shapes may be alone or in combination of two or more. Moreover, among these shapes, the quadrangle or the hexagon is preferable. By providing the cells 901a having such a shape, it is possible to reduce the pressure loss when the air 10 flows. In FIGS. 5 to 7, the honeycomb structure 90 is illustrated as an example in which the outer shape of the cross section and the shape of each cell 901a are quadrangular in the cross section orthogonal to the flow path direction of the honeycomb structure 90.

The honeycomb structure 90 may be a honeycomb joined body that includes a plurality of honeycomb segments and joining layers that join outer peripheral side surfaces of the plurality of honeycomb segments together. The use of the honeycomb joined body can increase the total cross-sectional area of the cells 901a, which is important for ensuring the flow rate of the air 10, while suppressing cracking.

It should be noted that the joining layer can be formed by using a joining material. The joining material is not particularly limited, but a ceramic material obtained by adding a solvent such as water to form a paste can be used. The joining material may contain a material having a PTC property, or may contain the same material as the outer wall 900 and the partition walls 901. In addition to the role of joining the honeycomb segments to each other, the joining material can also be used as an outer peripheral coating material after joining the honeycomb segments.

From the viewpoints of ensuring the strength of the honeycomb structure 90, reducing pressure loss when the air 10 passes through the cells 901a, ensuring the amount of functional material supported, and ensuring the contact area with the air 10 flowing inside the cells 901a, it is desirable to suitably combine a thickness of the partition wall 901, a cell density, and a cell pitch (or an opening ratio of the cells 901a).

As used herein, the cell density refers to a value obtained by dividing a number of cells by an area of one end face (first end face 90a or second end face 90b) of the honeycomb structure 90 (the total area of the partition walls 901 and the cells 901a excluding the outer wall 900).

As used herein, the cell pitch refers to a value obtained by the following calculation. First, the area of one end face (first end face 90a or second end face 90b) of the honeycomb structure 90 (the total area of the partition walls 901 and the cells 901a excluding the outer wall 900) is divided by the number of the cells to calculate an area per a cell. A square root of the area per a cell is then calculated, and this is determined to be the cell pitch.

As used herein, the opening ratio of the cells 901a refers a value obtained by dividing the total area of the cells 901a defined by the partition walls 901 by the area of one end face (first end face 90a or second end face 90b) (the total area of the partition walls 901 and the cells 901a excluding the outer wall 900) in the cross section orthogonal to the flow path direction of the honeycomb structure 90. In addition, when calculating the opening ratio of the cells 901a, the first electrode 92, the second electrode 93, and an adsorbing layer 91 as described below are not taken into consideration.

In an embodiment that is advantageous from the viewpoint of supporting a sufficient amount of functional material, the thickness of the partition walls 901 is 0.300 mm or less, the cell density is 140 cells/cm² or less, and the cell pitch is 0.85 mm or more. In a preferred embodiment, the thickness of the partition walls 901 is 0.200 mm or less, the cell density is 120 cells/cm² or less, and the cell pitch is 0.91 mm or more. In a more preferred embodiment, the thickness of the partition walls 901 is 0.160 mm or less, the cell density is 110 cells/cm² or less, and the cell pitch is 0.95 mm or more.

In each embodiment as described above, from the viewpoints of ensuring the strength of the honeycomb structure 90 and maintaining lower electrical resistance, the lower limit of the thickness of the partition walls 901 is preferably 0.010 mm or more, more preferably 0.020 mm or more, and even more preferably 0.030 mm or more.

In each embodiment described above, from the viewpoints of ensuring the strength of the honeycomb structure 90, maintaining lower electrical resistance, and increasing a surface area to facilitate reaction, adsorption, and desorption, the lower limit of the cell density is 30 cells/cm² or more, and preferably 35 cells/cm² or more, and even more preferably 40 cells/cm² or more.

In each embodiment as described above, from the viewpoints of ensuring the strength of the honeycomb structure 90, maintaining lower electrical resistance and increasing a surface area to facilitate reaction, adsorption and release, the upper limit of the cell pitch is preferably 2.0 mm or less, more preferably 1.8 mm or less, and even more preferably 1.6 mm or less.

In an embodiment that is advantageous in terms of both reducing pressure loss and maintaining strength, the thickness of the partition walls 901 is 0.08 to 0.36 mm, the cell density is 2.54 to 140 cells/cm², and the opening ratio of the cells 901a is 0.70 or more. In a preferred embodiment, the thickness of the partition walls 901 is 0.09 to 0.35 mm, the cell density is 15 to 100 cells/cm², and the opening ratio of the cells 901a is 0.80 or more. In a more preferred embodiment, the thickness of the partition walls 901 is 0.14 to 0.30 mm, the cell density is 20 to 90 cells/cm², and the opening ratio of the cells 901a is 0.85 or more.

In each embodiment as described above, from the viewpoint of ensuring the strength of the honeycomb structure 90, the upper limit of the opening ratio of the cells 901a is preferably 0.94 or less, more preferably 0.92 or less, and even more preferably 0.90 or less.

Although the thickness of the outer wall 900 is not particularly limited, it is preferably determined based on the following considerations. First, from the viewpoint of reinforcing the honeycomb structure 90, the thickness of the outer wall 900 is preferably 0.05 mm or more, more preferably 0.06 mm or more, and even more preferably 0.08 mm or more. On the other hand, when the viewpoint of suppressing the initial current by increasing the electrical resistance and from the viewpoint of reducing pressure loss when air flows are considered, the thickness of the outer wall 900 is preferably 1.0 mm or less, more preferably 0.5 mm, even more preferably 0.4 mm or less, and still more preferably 0.3 mm or less.

As used herein, the thickness of the outer wall 900 refers to a length, in a normal line direction of a side surface of the honeycomb structure 90, from a boundary between the outer wall 900 and the outermost cell 901a or the partition wall 901 to the side surface of the honeycomb structure 90 in the cross section orthogonal to the flow path direction of the honeycomb structure 90.

The length of the honeycomb structure 90 in the flow path direction and the cross-sectional area orthogonal to the flow path direction may be adjusted according to the required size of the humidity controlling device 2, and are not particularly limited. For example, when used in a compact humidity controlling device 2 while ensuring a predetermined function, the honeycomb structure 90 can have a length of 2 to 20 mm in the flow path direction and a cross-sectional area of 10 cm² or more orthogonal to the flow path direction. Although the upper limit of the cross-sectional area orthogonal to the flow path direction of the honeycomb structure 90 is not particularly limited, it is, for example, 300 cm².

The partition walls 901 forming the honeycomb structure 90 are made of a material that can be heated by electric conduction, specifically made of a material having the PTC property. Further, the outer wall 900 may also be made of a material having a PTC property, as with the partition walls 901, as needed. By such a configuration, the adsorbing layer 91 can be directly heated by heat transfer from the heat-generating partition walls 901 (and optionally the outer wall 900). Further, the material having the PTC property has characteristics such that when the temperature increases to exceed the Curie point, the resistance value is sharply increased, making it difficult for electricity to flow. Therefore, when the temperature of the humidity controlling device 2 becomes high, the partition walls 901 (and the outer wall 900 if necessary) have limited current flowing through them, thereby suppressing excessive heat generation of the humidity controlling device 2. Therefore, it is possible to suppress thermal deterioration of the adsorbing layer 91 due to excessive heat generation.

From the viewpoint of obtaining appropriate heat generation, the lower limit of the volume resistivity at 25° C. of the material having the PTC property is preferably 0.5 Ω·cm or more, and more preferably 1 Ω·cm or more, and even more preferably 5 Ω·cm or more. From the viewpoint of generating heat with a low driving voltage, the upper limit of the volume resistivity at 25° C. of the material having the PTC property is preferably 170 Ω·cm or less, and more preferably 160 Ω·cm or less, and even more preferably 150 Ω·cm or less. As used herein, the volume resistivity at 25° C. of the material having the PTC property is measured according to JIS K 6271:2008.

From the viewpoints that can be heated by electric conduction and has the PTC property, the outer wall 900 and the partition walls 901 are preferably made of a material containing barium titanate (BaTiO₃) as a main component. Also, this material is more preferably ceramics made of a material containing barium titanate (BaTiO₃)-based crystals as a main component in which a part of Ba is substituted with a rare earth element. As used herein, the term “main component” means a component in which a proportion of the component is more than 50% by mass of the total component. The content of BaTiO₃-based crystalline particles can be determined by fluorescent X-ray analysis. Other crystalline particles can be measured in the same manner as this method.

The compositional formula of BaTiO₃-based crystalline particles, in which a part of Ba is substituted with the rare earth element, can be expressed as (Ba₁₋ₓAₓ) TiO₃. In the compositional formula, the symbol A represents at least one rare earth element, and 0.001≤x≤0.010.

The symbol A is not particularly limited as long as it is the rare earth element, but it may preferably be one or more selected from the group consisting of La, Ce, Pr, Nd, Eu, Gd, Dy, Ho, Er, Y and Yb, and more preferably La. The x value is preferably 0.001 or more, and more preferably 0.0015 or more, in terms of suppressing excessively high electrical resistance at room temperature. On the other hand, x is preferably 0.009 or less, in terms of preventing the electrical resistance at room temperature from becoming too high due to insufficient sintering.

The content of the BaTiO₃-based crystalline particles in which a part of Ba is substituted with the rare earth element in the ceramics is not particularly limited as long as it is determined to be the main component, but it may preferably be 90% by mass or more, and more preferably 92% by mass or more, and even more preferably 94% by mass or more. The upper limit of the content of the BaTiO₃-based crystalline particles is not particularly limited, but it may generally be 99% by mass, and preferably 98% by mass.

The content of the BaTiO₃-based crystalline particles can be measured by fluorescent X-ray analysis. Other crystalline particles can be measured in the same manner as this method.

In terms of reduction of the environmental load, it is desirable that the materials used for the outer wall 900 and the partition walls 901 are substantially free of lead (Pb). Specifically, the outer wall 900 and the partition walls 901 preferably have a Pb content of 0.01% by mass or less, and more preferably 0.001% by mass or less, and still more preferably 0% by mass. The lower Pb content can allow the air 10 heated by contact with the heat-generating partition walls 901 to be safely applied to organisms such as humans, for example. In the outer wall 900 and the partition walls 901, the Pb content is preferably less than 0.03% by mass, more preferably less than 0.01% by mass, and even more preferably 0% by mass, as converted to PbO. The lead content can be determined by ICP-MS (inductively coupled plasma mass spectrometry).

In terms of efficiently heating the air, the material making up the outer wall 900 and the partition walls 901 preferably have a lower limit of a Curie point of 80° C. or more, more preferably 80° C. or more, and even more preferably 100° C. or more. Further, in terms of safety as a component placed in the vehicle interior or near the vehicle interior, the upper limit of the Curie point is preferably 250° C. or more, more preferably 225° C. or more, even more preferably 200° C. or more, and still more preferably 150° C. or more.

The Curie point of the material making up the outer wall 900 and the partition walls 901 can be adjusted by the type and amount of shifter added. For example, the Curie point of barium titanate (BaTIO₃) is about 120° C., but the Curie point can be shifted to the lower temperature side by substituting a part of Ba and Ti with one or more of Sr, Sn and Zr.

As used herein, the Curie point is measured by the following method. A sample is attached to a sample holder for measurement, mounted in a measuring tank (e.g., MINI-SUBZERO MC-810P, from ESPEC), and a change in electrical resistance of the sample as a function of a temperature change when the temperature is increased from 10° C. is measured using a DC resistance meter (e.g., Multimeter 3478A, from YOKOGAWA HEWLETT PACKARD, LTD.). Based on an electrical resistance-temperature plot obtained by the measurement, a temperature at which the resistance value is twice the resistance value at room temperature (20° C.) is defined as the Curie point.

### (2-2. Regarding First Electrode and Second Electrode)

The first electrode 92 and the second electrode 93 are provided on the first end face 90a and the second end face 90b, respectively. Applying a voltage between the first electrode 92 and the second electrode 93 allows the honeycomb structure 90 to generate heat by Joule heat.

The first electrode 92 and the second electrode 93 may employ, for example, a metal or alloy containing at least one selected from Cu, Ag, Al, Ni and Si, although not particularly limited thereto. It is also possible to use an ohmic electrode capable of ohmic contact with the outer wall 900 and/or the partition walls 901 which have the PTC property. The ohmic electrode may employ an ohmic electrode containing, for example, at least one selected from Al, Au, Ag and In as a base metal, and containing at least one selected from Ni, Si, Zn, Ge, Sn, Se and Te for n-type semiconductors as a dopant. Further, the first electrode 92 and the second electrode 93 may have a single-layer structure, or may have a laminated structure of two or more layers. When the first electrode 92 and the second electrode 93 have the laminated structure of two or more layers, the materials of the respective layers may be of the same type or of different types.

The thicknesses of the first electrode 92 and the second electrode 93 may be appropriately set according to the method for forming the first electrode 92 and the second electrode 93. The method for forming the first electrode 92 and the second electrode 93 includes metal deposition methods such as sputtering, vapor deposition, electrolytic deposition, and chemical deposition. Alternatively, the first electrode 92 and the second electrode 93 can be formed by applying an electrode paste and then baking it, or by thermal spraying. Furthermore, the first electrode 92 and the second electrode 93 may be formed by joining metal sheets or alloy sheets.

Each thickness of the first electrode 92 and the second electrode 93 is, for example, about 5 to 30 μm for baking the electrode paste, and about 100 to 1000 nm for dry plating such as sputtering and vapor deposition, and about 10 to 100 μm for thermal spraying, and about 5 μm to 30 μm for wet plating such as electrolytic deposition and chemical deposition. Further, when joining the metal sheet or alloy sheet, each thickness is preferably about 5 to 100 μm.

### (2-3. Regarding First Metal Terminal and Second Metal Terminal)

The provision of the first metal terminal 94 and the second metal terminal 95 facilitates connection to an external power source. The first metal terminal 94 and the second metal terminal 95 are connected to a conductor connected to the external power source.

The metal that makes up the first metal terminal 94 and the second metal terminal 95 may include single metals, alloys, and the like, but from the viewpoint of corrosion resistance, electrical resistivity, and coefficient of linear expansion, it may preferably be alloys containing at least one selected from the group consisting of Cr, Fe, Co, Ni, Cu, Al, and Ti, and more preferably stainless steel, Fe—Ni alloy, and phosphor bronze. Furthermore, the thickness of each of the first metal terminal 94 and the second metal terminal 95 is not particularly limited, but it is, for example, 0.01 to 10 mm, typically 0.05 to 5 mm.

The method of connecting the first metal terminal 94 and the second metal terminal 95 to the first electrode 92 and the second electrode 93, respectively, is not particularly limited as long as they are electrically connected. For example, they can be connected by diffusion bonding, a mechanical pressing mechanism, welding, or the like.

### (2-4. Regarding Intermediate Material)

Intermediate materials may be provided between: the first electrode 92 and the second electrode 93; and the first metal terminal 94 and the second metal terminal 95. The provision of the intermediate materials results in high structural freedom of the connection between the first electrode 92 and the second electrode 93 and the first metal terminal 94 and the second metal terminal 95. The intermediate material may be made of non-limiting materials, and it may be the same as the material of the first metal terminal 94 and the second metal terminal 95 as described above. Moreover, the material of the intermediate material may be different from that of the first metal terminal 94 and the second metal terminal 95 as described above. In this case, the intermediate material can be made of a solder, a brazing material, a conductive adhesive, or the like. The method of connecting the intermediate materials to the first metal terminal 94 and the second metal terminal 95 and the first electrode 92 and the second electrode 93 is not particularly limited as long as they are electrically connected. For example, they can be connected by diffusion bonding, a mechanical pressing mechanism, welding, or the like.

### (2-5. Regarding Adsorbing Layer)

As illustrated in FIG. 7, the humidity controlling device 2 may be provided with an adsorbing layer 91 on each surface of the partition walls 901. The adsorbing layer 91 can be provided on the surfaces of the partition walls 901 (in the case of the outermost cells 901a, the partition walls 901 that define the outermost cells 901a and the outer wall 900). By thus providing the adsorbing layer 91, the functional material contained in the adsorbing layer 91 can be easily heated, so that the desired function due to the functional material can be exerted.

The adsorbent contained in the adsorbing layer 91 is not particularly limited as long as it can exhibit the desired function. The adsorbent has a function of adsorbing moisture, carbon dioxide and/or volatile components in the air. The adsorbing layer 91 may further contain a catalyst. This can allow the adsorption target substances to be purified. By using the adsorbent in combination with the catalyst, the function of the adsorbent to capture the adsorption target substances can be improved.

The adsorbent preferably has a function that can adsorb the adsorption target substances, for example, moisture, carbon dioxide and volatile components, etc., at −20 to 40° C. and desorb them at an elevated temperature of 60° C. or more. Examples of the adsorbent having such a function include zeolite, silica gel, activated carbon, alumina, silica, low-crystalline clay, amorphous aluminum silicate complexes, and the like. The type of the adsorbent may be appropriately selected depending on the types of the adsorption target substances. The adsorbent may be used alone, or in combination with two or more types.

The catalyst preferably has a function capable of promoting the oxidation-reduction reaction. The catalyst having such a function includes metal catalysts such as Pt, Pd and Ag, and oxide catalysts such as CeO₂ and ZrO₂. The catalyst may be used alone or in combination of two or more types.

The volatile components contained in the air in the vehicle interior are, for example, volatile organic compounds (VOCs) and odor components other than the VOCs. Specific examples of the volatile components include ammonia, acetic acid, isovaleric acid, nonenal, formaldehyde, toluene, xylene, paradichlorobenzene, ethylbenzene, styrene, chlorpyrifos, di-n-butyl phthalate, tetradecane, and di-2-ethylhexyl phthalate, diazinon, acetaldehyde, 2-(1-methylpropyl)phenyl N-methylcarbamate, and the like.

The thickness of the adsorbing layer 91 may be determined according to the size of the cells 901a, and is not particularly limited. For example, from the viewpoint of ensuring sufficient contact with the air 10, the thickness of the adsorbing layer 91 is preferably 20 μm or more, more preferably 25 μm or more, and even more preferably 30 μm or more. On the other hand, from the viewpoint of suppressing separation of the adsorbing layer 91 from the partition walls 901 and the outer wall 900, the thickness of the adsorbing layer 91 is preferably 400 μm or less, more preferably 380 μm or less, and even more preferably 350 μm or less.

The thickness of the adsorbing layer 91 is measured using the following procedure. Any cross section of the honeycomb structure 90 parallel to the flow path direction is cut out, and a cross-sectional image at magnifications of about 50 is acquired using a scanning electron microscope or the like. Also, this cross section is made to pass through the center of gravity position in the cross section orthogonal to the flow path of the honeycomb structure 90. The thickness of each adsorbing layer 91 visually recognized from the cross-sectional image is calculated by dividing the cross-sectional area by the length of the cells 901a in the flow path direction. This calculation is performed for all the adsorbing layers 91 visually recognized from the cross-sectional image, and an average value thereof is determined to be the thickness of the adsorbing layer 91.

From the viewpoint that the functional material exerts a desired function in the humidity controlling device 2, an amount of the adsorbing layer 91 is preferably 50 to 500 g/L, more preferably 100 to 400 g/L, and even more preferably 150 to 350 g/L, based on the volume of the honeycomb structure 90. It should be noted that the volume of the honeycomb structure 90 is a value determined by the external dimensions of the honeycomb structure 90.

### (3. Regarding Method for Producing Humidity Controlling Device)

The method for producing the humidity controlling device 2 according to an embodiment of the invention is not particularly limited as long as it is a method having the characteristics as described above, and can be carried out in accordance with a known method. Hereinafter, the method for producing the humidity controlling device 2 according to an embodiment of the invention will be specifically described.

A method for producing the honeycomb structure 90 forming the humidity controlling device 2 includes a forming step and a firing step.

In the forming step, a green body containing a ceramic raw material including BaCO₃ powder, TiO₂ powder, and rare earth nitrate or hydroxide powder is formed to prepare a honeycomb formed body having a relative density of 60% or more.

The ceramic raw material can be obtained by dry-mixing the powders so as to have a desired composition.

The green body can be obtained by adding a dispersion medium, a binder, a plasticizer and a dispersant to the ceramic raw material and kneading them together. The green body may optionally contain additives such as shifters, metal oxides, property improving agents, and conductor powder.

The blending amount of the components other than the ceramic raw material is not particularly limited as long as the relative density of the honeycomb formed body is 60% or more.

As used herein, the “relative density of the honeycomb formed body” means a ratio of the density of the honeycomb formed body to the true density of the entire ceramic raw material. More particularly, the relative density can be determined by the following equation:

relative density of honeycomb formed body (%)=density of honeycomb formed body (g/cm³)/true density of entire ceramic raw material (g/cm³)×100.

The density of the honeycomb formed body can be measured by the Archimedes method using pure water as a medium. Further, the true density of the entire ceramic raw material can be obtained by dividing the total mass of the respective raw materials (g) by the total of the actual volumes of the respective raw materials (cm³).

Examples of the dispersion medium include water or a mixed solvent of water and an organic solvent such as alcohol, and more preferably water.

Examples of the binder include organic binders such as methyl cellulose, hydroxypropoxyl cellulose, hydroxyethyl cellulose, carboxymethyl cellulose, and polyvinyl alcohol. In particular, it is preferable to use methyl cellulose in combination with hydroxypropoxyl cellulose. The binder may be used alone, or in combination of two or more, but it is preferable that the binder does not contain an alkali metal element.

Examples of the plasticizer include polyoxyalkylene alkyl ethers, polycarboxylic acid-based polymers, and alkyl phosphate esters.

The dispersant that can be used herein includes surfactants such as polyoxyalkylene alkyl ether, ethylene glycol, dextrin, fatty acid soaps, and polyalcohol. The dispersant may be used alone or in combination of two or more.

The honeycomb formed body can be produced by extruding the green body. For the extrusion, a die having a desired overall shape, cell shape, partition wall thickness, cell density and the like can be used.

The relative density of the honeycomb formed body obtained by extrusion is 60% or more, and preferably 65% or more. By limiting the relative density of the honeycomb formed body to such a range, the honeycomb formed body can be densified and the electrical resistance at room temperature can be reduced. The upper limit of the relative density of the honeycomb formed body is not particularly limited, but it may generally be 80%, and preferably 75%.

The honeycomb formed body can be dried before the firing step. Non-limiting examples of the drying method include known drying methods such as hot air drying, microwave drying, dielectric drying, drying under reduced pressure, drying in vacuum, and freeze drying. Among these, a drying method that combines the hot air drying with the microwave drying or dielectric drying is preferable because the entire formed body can be rapidly and uniformly dried.

The firing step includes maintaining the formed body at a temperature of from 1150 to 1250° C., and then increasing the temperature to a maximum temperature of from 1360 to 1430° C. at a heating rate of 20 to 600° C./hour, and maintaining the temperature for 0.5 to 10 hours.

The maintaining of the honeycomb formed body at the maximum temperature of from 1360 to 1430° C. for 0.5 to 10 hours can provide the honeycomb structure 90 containing, as a main component, BaTiO₃-based crystal particles in which a part of Ba is substituted with the rare earth element.

Further, the maintaining at the temperature of from 1150 to 1250° C. can allow the Ba₂TiO₄ crystal particles generated in the firing process to be easily removed, so that the honeycomb structure 90 can be densified.

Further, the heating rate of 20 to 600° C./hour from the temperature of 1150 to 1250° C. to the maximum temperature of 1360 to 1430° C. can allow 1.0 to 10.0% by mass of Ba₆Ti₁₇O₄₀ crystal particles to be formed in the honeycomb structure 90.

The amount of time when the honeycomb formed body is maintained at 1150 to 1250° C. is not particularly limited, but it may preferably be from 0.5 to 10 hours. Such a maintaining time can lead to stable and easy removal of Baz TiO₄ crystal particles generated in the firing process.

The firing step preferably includes maintaining the honeycomb formed body at 900 to 950° C. for 0.5 to 5 hours while the temperature is increased. The maintaining at 900 to 950° C. for 0.5 to 5 hours can lead to sufficient decomposition of BaCO₃, so that the honeycomb structure 90 having a predetermined composition can be easily obtained.

Prior to the firing step, a degreasing step for removing the binder may be performed. The degreasing step may preferably be performed in an air atmosphere in order to decompose the organic components completely.

Also, the atmosphere of the firing step may preferably be the air atmosphere in terms of control of electrical characteristics and production cost.

A firing furnace used in the firing step and the degreasing step is not particularly limited, but it may be an electric furnace, a gas furnace, or the like.

The first electrode 92 and the second electrode 93 are formed on the honeycomb structure 90 thus obtained, whereby the humidity controlling device 2 can be produced. The first electrode 92 and the second electrode 93 can also be formed by metal deposition methods such as sputtering, vapor deposition, electrolytic deposition, and chemical deposition. Further, the first electrode 92 and the second electrode 93 can also be formed by applying an electrode paste and then baking it. Furthermore, the first electrode 92 and the second electrode 93 can also be formed by thermal spraying. The first electrode 92 and the second electrode 93 may be composed of a single layer, but may also be composed of a plurality of electrode layers having different compositions. A typical method for forming the first electrode 92 and the second electrode 93 will be described below.

First, an electrode slurry containing an electrode material, an organic binder, and a dispersion medium is prepared, and the first end face 90a or the second end face 90b of the honeycomb structure 90 is coated with the slurry. The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof. An excess slurry on the periphery of the honeycomb structure 90 is removed by blowing and wiping. The slurry can be then dried to form the first electrode 92 and the second electrode 93 on the first end face 90a or the second end face 90b of the honeycomb structure 90. The drying can be performed while heating the humidity controlling device 2 to a temperature of about 120 to 600° C., for example. Although a series of steps of coating, slurry removal, and drying may be performed only once, the steps can be repeated multiple times to provide the first electrode 92 and the second electrode 93 having desired thicknesses.

The first metal terminal 94 and the second metal terminal 95 are then placed at predetermined positions of the first electrode 92 and the second electrode 93, respectively, and the first electrode 92 and the second electrode 93 are connected to the first metal terminal 94 and the second metal terminal 95, respectively. As a method of connecting the first electrode 92 and the second electrode 93 to the terminals, the method described above can be used. Further, when the intermediate materials are provided between: the first electrode 92 and the second electrode 93; and the first metal terminal 94 and the second metal terminal 95, the intermediate material can be placed at a predetermined position of the first electrode 92 and the second electrode 93 and connected to each other, and then the first metal terminal 94 and the second metal terminal 95 can be placed at a predetermined position of the intermediate material and connected to each other. As a method for connecting these, the method as described above can be used.

It should be noted that the first metal terminal 94, the second metal terminal 95 and the intermediate material may be provided after the adsorbing layer 91 described below is formed.

The adsorbing layer 91 is then formed on each surface of the partition walls 901 and the like of the humidity controlling device 2 thus obtained, thereby obtaining a humidity controlling device with functional material-containing layers.

Although the method for forming the adsorbing layer 91 is not particularly limited, it can be formed, for example, by the following steps. The humidity controlling device 2 is immersed in a slurry containing a functional material, an organic binder, and a dispersion medium for a predetermined period of time, and an excess slurry on the end faces and the outer periphery of the honeycomb structure 90 is removed by blowing and wiping. The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof. The slurry can be then dried to form the adsorbing layer 91 on the surfaces of the partition walls 901. The drying can be performed while heating the humidity controlling device 2 to a temperature of about 120 to 600° C., for example. Although a series of steps of immersion, slurry removal, and drying may be performed only once, the steps can be repeated multiple times to provide the adsorbing layer 91 having the desired thickness on the surfaces of the partition walls 901 and the like.

While the preferred embodiments of the invention have been described above in detail with reference to the drawings, the present invention is not limited to such embodiments. It is obvious that a person skilled in the art to which this invention belongs can arrive at various variations or modifications in the scope of the technical idea recited in the claims, and it is understood that they also belong to the technical scope of this invention.

While the preferred embodiments of the invention have been described above in detail with reference to the drawings, the present invention is not limited to such embodiments. It is obvious that a person skilled in the art to which this invention belongs can arrive at various variations or modifications in the scope of the technical idea recited in the claims, and it is understood that they also belong to the technical scope of this invention.

### Examples

The invention will be more specifically described by means of the following Examples. The invention is not limited to these examples.

As ceramic raw materials were prepared BaCO₃ powder, TiO₂ powder, and La(NH₃)₃·6H₂O powder. These powders were weighed to have the required composition after firing, and dry-mixed to obtain a mixed powder. The dry mixing was performed for 30 minutes. To 100 parts by mass of the resulting mixed powder were then added water, a binder, a plasticizer, and a dispersant by an appropriate amount in the range of 3 to 30 parts by mass in total so as to obtain a ceramic formed body having a relative density of 64.8% after extrusion, and then kneaded to obtain a green body. Methylcellulose was used as the binder. Polyoxyalkylene alkyl ethers were used as the plasticizer and the dispersant.

The resulting green body was then fed into an extrusion molding machine and extruded using a predetermined die to form a honeycomb structure having the shape illustrated below after firing.

Shape of cross section and end face of honeycomb structure orthogonal to flow path direction: quadrangular;

Dimensions of honeycomb structure: horizontal width of 114 mm, vertical width of 114 mm, length of 10 mm;

Shape of cross section of cells orthogonal to flow path direction: quadrangular;

Thickness of partition walls: 0.127 mm;

Thickness of outer wall: 0.8 mm;

Cell density: 85.3 cells/cm²;

Cell pitch: 1.08 mm;

Opening Ratio of Cells: 0.55 to 0.80; Cross-sectional area of honeycomb structure orthogonal to extending direction of flow path: 13000 mm²;

Length of honeycomb structure in extending direction of flow path: 10 mm; Volume resistivity of materials making up partition walls (and outer wall) at 25° C.: 12 Ω·cm; and

Curie point of material making up partition walls (and outer wall): 120° C.

The volume resistivity of the partition walls was controlled by adjusting the mixing ratio of the raw materials and firing conditions.

Subsequently, the resulting honeycomb structure was subjected to dielectric drying and hot air drying, and then degreased (450° C. for 4 hours) in a sintering furnace in an air atmosphere, and then sintered in an air atmosphere. The firing was performed by maintaining the honeycomb structure at a temperature of 950° C. for 1 hour, then increasing the temperature to 1200° C. and maintaining it at 1200° C. for 1 hour, and then increasing the temperature to 1400° C. (maximum temperature) at a rate of 200° C./hour and maintaining it at a temperature of 1400° C. for 2 hours.

The first electrode and the second electrode each having a thickness of 0.05 mm were formed on both end faces (first end face and second end face) of the resulting honeycomb structure, respectively. The first electrode and the second electrode were formed as follows: First, an electrode slurry containing aluminum (electrode material), ethyl cellulose and diethylene glycol monobutyl ether (organic binder) was prepared and applied to the first end face. Subsequently, an excess electrode slurry on the outer periphery of the honeycomb structure was removed by blowing and wiping, and the electrode slurry was then dried to form an electrode on one end face. Similarly, an electrode was formed on the other end face.

The honeycomb structure with the first electrode and the second electrode formed was then immersed in a slurry containing zeolite (adsorbent) as a functional material, an organic binder, and water, and the slurry adhering to excess positions (such as the outer periphery) was removed by blowing and wiping, and then dried at about 550° C. to form a functional material-containing layer at the predetermined position.

Subsequently, the first metal terminal was joined onto the first electrode and the second metal terminal was joined onto the second electrode. The first metal terminal and the second metal terminal were joined as follows: Each of the first metal terminal and the second metal terminal used was a strip-shaped metal body made of SUS430 and having a width of 3.5 mm and a thickness of 0.7 mm. The overall outer shape of the first metal terminal and the second metal terminal was a rectangular frame shape. The first metal terminal and the second metal terminal were joined by soldering onto the first electrode and the second electrode, respectively, while aligning the outer edges of the first metal terminal and the second metal terminal with the outer edges of both end faces of the honeycomb structure, respectively. The flow blocking portion 22 was formed by the first metal terminal and the second metal terminal.

A sample of the humidity controlling device obtained as described above was placed inside the duct. At this time, the maximum width of the flow blocking portion when the end face of the humidity controlling device in the duct was viewed from the downstream side in the flow direction of the air was changed as shown in Table 1 below.

TABLE 1

| | | Absolute Humidity Downstream |
|---|---|---|
| | Maximum Width of | of Humidity Controlling Device |
| | Flow Blocking | (Average for 1 min) |
| | Portion (mm) | (g/m³) |
| Comp. | 25 | 4.1 |
| Ex. | 10 | 2.6 |
| Ex. | 9 | 2.3 |
| Ex. | 5 | 2.2 |

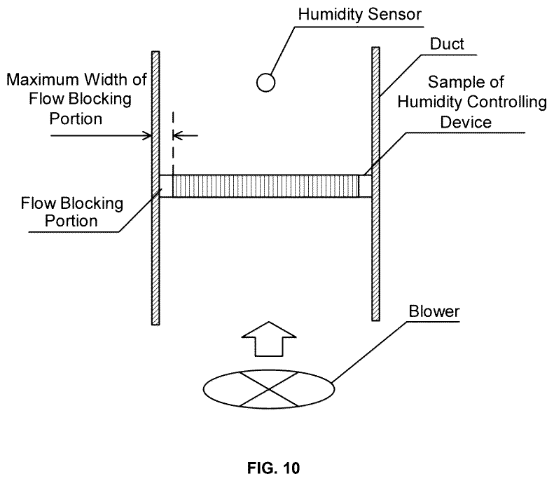

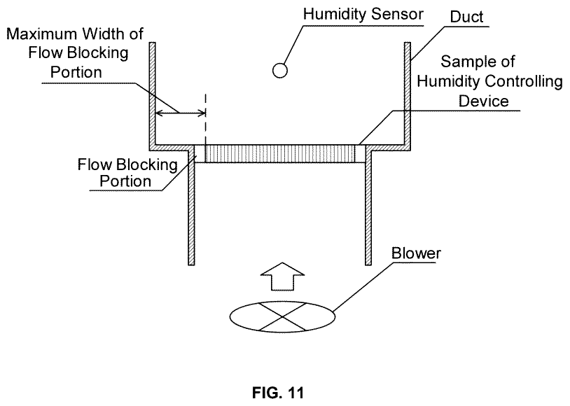

FIG. 10 illustrates an embodiment in which the maximum width of the flow blocking portion is set to 10 mm. FIG. 11 illustrates an embodiment in which the maximum width of the flow blocking portion is set to 25 mm. In the embodiment illustrated in FIG. 11, the maximum width was increased by increasing the width of the duct on the downstream side of the humidity controlling device in the flow direction of the air. In both embodiments, the blower was provided upstream of the humidity controlling device, and the humidity sensor was provided downstream of the humidity controlling device. The distance between the end face of the humidity controlling device and the humidity sensor was 70 mm.

As described above, the regeneration mode and the moisture absorption mode were performed with the sample of the humidity controlling device provided in the duct. The regeneration mode was performed by starting the blower and allowing the air at a temperature of 25° C. and at relative humidity of 40% to flow at a flow velocity of 0.07 m/s into the duct while applying a voltage of 12 V from a direct current power source to the humidity controlling device for 3 minutes. The moisture absorption mode was performed by allowing the air under the same conditions to flow into the duct for one minute at a flow velocity of 0.9 m/s, without applying a voltage to the humidity controlling device. In the moisture absorption mode, the absolute humidity [g/m³] was measured by the humidity sensor placed downstream of the humidity controlling device. Table 1 also shows the results.

When the maximum width of the flow blocking portion was 25 mm, the absolute humidity downstream of the humidity controlling device was 4.1 g/m³, whereas, when the maximum width of the flow blocking portion was 10 mm, the absolute humidity downstream of the humidity controlling device was 2.6 g/m³. When the maximum width of the flow blocking portion was 25 mm, it is believed that the air accumulated downstream of the humidity controlling device in the flow direction of the air, resulting in an increase in absolute humidity downstream of the humidity controlling device. On the other hand, when the maximum width of the flow blocking portion was 10 mm, it is believed that there was less air accumulation downstream of the humidity controlling device in the flow direction of the air, resulting in a decrease in the absolute humidity downstream of the humidity controlling device. It was confirmed from these results that the maximum width of the flow blocking portion when the end face of the humidity controlling device in the duct was viewed from the downstream side in the flow direction of the air could be 10 mm or less, thereby reducing the probability of moisture desorbed from the adsorbent remaining in the duct and reducing the probability of that moisture being introduced into the vehicle interior. When the maximum width of the flow blocking portion was 9 mm, the absolute humidity downstream of the humidity controlling device became lower, and when the maximum width of the flow blocking portion was 5 mm, the absolute humidity downstream of the humidity controlling device became further lower. It was confirmed from these results that the maximum width of the flow blocking portion was preferably 9 mm, and even more preferably 5 mm.

### DESCRIPTION OF REFERENCE NUMERALS

1: vehicle air conditioning system
2: humidity controlling device
3: duct
10: air
10a: moisture
20: adsorption portion
21: heating means
22: flow blocking portion
23: flow permitting portion
31: first flow path
32: second flow path
90: honeycomb structure
90a: first end face
90b: second end face
91: adsorbing layer
92: electrode
93: electrode
96: frame body
900: outer wall
901: partition wall

1. A vehicle air conditioning system, comprising:
a humidity controlling device having an adsorption portion containing an adsorbent configured to adsorb moisture at a temperature lower than or equal to a predetermined temperature and to desorb the moisture when the temperature exceeds the predetermined temperature, and a heating means configured to heat the adsorption portion; and
a duct having the humidity controlling device provided therein and allowing air from a vehicle interior or a vehicle exterior of a vehicle to flow therethrough, the duct having a first flow path for allowing the air to flow into the vehicle interior on a downstream side of the humidity controlling device and a second flow path for discharging the air to the vehicle exterior;
wherein an end face of the humidity controlling device comprises: a flow blocking portion disposed in a band shape around an outer periphery of the end face to block the flow of the air; and a flow permitting portion disposed on an inner side of the flow blocking portion to permit the flow of the air, and
wherein the flow blocking portion has a maximum width of 10 mm or less, when the end face of the humidity controlling device in the duct is viewed from a downstream side in a flow direction of the air.

2. The vehicle air conditioning system of claim 1, wherein the maximum width of the flow blocking portion is 9 mm or less.

3. The vehicle air conditioning of claim 1, wherein the humidity controlling device further comprises frame bodies that sandwich the adsorption portion from both sides in the flow direction of the air, and the flow blocking portion is at least partially formed of the frame bodies.

4. The vehicle air conditioning system of claim 1, wherein the adsorption portion comprises: a honeycomb structure having an outer wall and partition walls provided on an inner side of the outer wall, the partition walls defining cells to form flow paths for the air, each of the cells extending from a first end face to a second end face of the honeycomb structure; and an adsorbing layer containing an adsorbent provided on a surface of each of the partition walls, and
wherein the heating means comprises a pair of electrodes connected to the honeycomb structure, the heating means being configured to heat the honeycomb structure by passing a current through the honeycomb structure via the pair of electrodes, and
wherein at least the partition walls of the honeycomb structure are made of a material having a positive temperature coefficient (PTC) property.
